(19) United States
(12) Patent Application Publication
(10) Pub. No.: US 2011/0305486 A1
(43) Pub. Date: Dec. 15, 2011

(54) TONER CONVEYING APPARATUS, TONER CARTRIDGE AND CLEANING UNIT HAVING THE TONER CONVEYING APPARATUS

(76) Inventors: Toshihide OHGOSHI, Osaka (JP); Takafumi Nagai, Osaka (JP)

(21) Appl. No.: 13/158,790

(22) Filed: Jun. 13, 2011

(30) Foreign Application Priority Data
Jun. 11, 2010 (JP) 2010-133980

(51) Int. Cl. G03G 15/08; G03G 21/00

(52) U.S. Cl. 399/263; 399/358

(57) ABSTRACT

A toner conveying apparatus comprising:
a toner conveying barrel having a toner conveying path arranged inside, a toner inlet arranged on an upstream side of the toner conveying path in order to introduce toner from an outside into the toner conveying path and a toner outlet arranged on a downstream side of the toner conveying path in order to discharge the toner out of the toner conveying path; and
a screw shaft provided in the toner conveying barrel rotatably and conveying the toner in the toner conveying path from the upstream side to the downstream side, wherein
the screw shaft has a rotating shaft and a spiral blade mounted to the rotating shaft,
the spiral blade has a rigid spiral section fixed to the rotating shaft, and a spiral spring section arranged on a position facing the toner outlet on a downstream side with respect to a downstream side end portion of the rigid spiral section,
   only an upstream side end portion of the spiral spring section is fixed to the downstream side end portion of the rigid spiral section or the rotating shaft portion near the downstream side end portion of the rigid spiral section, and the spiral spring section can elastically expands and contracts to a direction of the rotating shaft.

### CROSS-REFERENCE TO RELATED APPLICATION

This application is related to Japanese patent application No. 2010-133980 filed on Jun. 11, 2010 whose priority is claimed under 35 USC §119, the disclosure of which is incorporated by reference in its entirety.

### BACKGROUND OF THE INVENTION

1. Field of the Invention

The present invention relates to a toner conveying apparatus to be used in an image forming apparatus using an electrophotographic system, and a toner cartridge and a cleaning unit having the toner conveying apparatus.

2. Description of the Related Art

In image forming apparatuses of an electrophotographic system using a two-component developer, when toner in a developing section is consumed and reduced by image formation, toner is replenished into the developing section from toner cartridges in order to prevent toner concentrations of the developers from being a predetermined value or less.

As conventional toner cartridges that are attached to image forming apparatuses detachably, the following toner cartridge is proposed (for example, see Japanese Patent Application Laid-Open No. 2006-235255). This toner cartridge includes a toner reservoir for housing replenishment toner, a toner outlet for discharging a toner towards a developing section, and an auger screw for conveying the toner from the toner reservoir to the toner outlet.

However, in a case of the conventional toner cartridge, a toner discharge section whose space becomes narrow is provided onto a downstream side of a toner conveying path. Fluidity of toner in the toner discharge section is deteriorated due to long-distance transport and a long-time untouched state, and thus the toner tends easily to agglutinate.

When the auger screw rotates and the toner is conveyed to the downstream side of the toner conveying path in this state, the toner adheres to a wall surface on a lowest-stream side of the toner conveying path and accumulates. The accumulated toner is excessively pressed against the wall surface of the lowest-stream side by toner successively conveyed and thus is easily in a consolidation state.

When the toner in the consolidation state is continuously pressed against the wall surface on the lowest-stream side and becomes a mass, finally the toner mass inhibits the rotation of the auger screw, namely, a lock phenomenon occurs in some cases.

### SUMMARY OF THE INVENTION

The present invention is devised in view of such a problem, and its object is to provide a toner conveying apparatus for repressing a toner consolidation state near a toner outlet in a toner conveying path so as to preventing a lock phenomenon, a toner cartridge and a cleaning unit having the toner conveying apparatus.

According to the present invention, a toner conveying apparatus (first invention) is provided. The toner conveying apparatus includes: a toner conveying barrel having a toner conveying path arranged inside, a toner inlet arranged on an upstream side of the toner conveying path in order to introduce toner from an outside into the toner conveying path and a toner outlet arranged on a downstream side of the toner conveying path in order to discharge the toner out of the toner conveying path; and a screw shaft provided in the toner conveying barrel rotatably and conveying the toner in the toner conveying path from the upstream side to the downstream side. The screw shaft has a rotating shaft and a spiral blade mounted to the rotating shaft. The spiral blade has a rigid spiral section fixed to the rotating shaft, and a spiral spring section arranged on a position facing the toner outlet on a downstream side with respect to a downstream side end portion of the rigid spiral section. Only an upstream side end portion of the spiral spring section is fixed to the downstream side end portion of the rigid spiral section or the rotating shaft portion near the downstream side end portion of the rigid spiral section, and the spiral spring section can elastically expands and contracts to a direction of the rotating shaft.

Another aspect of the present invention provides a toner cartridge (second invention). The toner cartridge includes: a cartridge main body having the toner conveying apparatus and a toner housing section arranged adjacently to the toner conveying apparatus inside; a shutter provided on an outer surface side of the cartridge main body, for opening/closing the toner outlet in the toner conveying barrel; and a paddle member, provided into the cartridge main body rotatably, for feeding the toner in the toner housing section from the toner inlet in the toner conveying barrel into the toner conveying path.

Still another aspect of the present invention provides a cleaning unit (third invention) including the toner conveying apparatus and a blade member mounted to an opening edge of the toner inlet in the toner conveying barrel of the toner conveying apparatus.

Further, still another aspect of the present invention provides an image forming apparatus (fourth invention). The image forming apparatus includes: a photoconductor drum whose surface is formed with an electrostatic latent image; a developing section for supplying toner to the electrostatic latent image on the surface of the photoconductor drum and forming a toner image; the toner cartridge for replenishing the developing section with toner; a transfer section for transferring the toner image on the surface of the photoconductor drum to a recording medium; and a fixing section for fixing the toner image to the recording medium.

Still another aspect of the present invention provides an image forming apparatus (fifth invention). The imaging forming apparatus includes: a photoconductor drum whose surface is formed with an electrostatic latent image; a developing section for supplying toner to the electrostatic latent image on the surface of the photoconductor drum and forming a toner image; a transfer section for transferring the toner image on the surface of the photoconductor drum to a recording medium; a fixing section for fixing the toner image to the recording medium; a waste toner collecting section; and the cleaning unit in which the blade member is provided to touch the surface of the photoconductor drum. Residual toner on the surface of the photoconductor drum remaining after the transfer is removed by the cleaning unit, and is conveyed to the waste toner collecting section.

In the toner conveying apparatus of the present invention, the screw shaft has the spiral spring section arranged on the position facing the toner outlet on the downstream side with respect to the downstream side end portion of the rigid spiral section. Only the upstream side end portion of the spiral spring section is fixed to the downstream side end portion of the rigid spiral section or the rotating shaft portion near the downstream side end portion of the rigid spiral section. The spiral spring section elastically expands and contracts to the direction of the rotating shaft.

When the screw shaft conveys the toner in the toner conveying path from upstream side to the downstream side, the toner whose fluidity is low is temporarily accumulated near the toner outlet in some cases. However, according to the present invention, when the spiral spring section is elastically compressed to the direction of the rotating shaft, application of an excessive compressing force to the toner is repressed. As a result, a toner consolidation state is repressed, and thus a lock phenomenon of an auger screw caused by the toner consolidation state can be prevented.

Even if the toner with low fluidity is temporarily accumulated near the toner outlet, the continuous rotation of the spiral spring section allows the toner to be discharged from the toner outlet, and thus the compressed spiral spring section is restored.

Therefore, according to the toner cartridge and the image forming apparatus having the toner conveying apparatus, the lock phenomenon of the screw shaft is prevented, and toner can be supplied to the developing section stably. For this reason, an image with stable image concentration can be formed on a recording medium.

According to the cleaning unit and the image forming apparatus having the toner conveying apparatus, since the lock phenomenon of the screw shaft is prevented, the following accident can be prevented. The accident is such that the cleaning unit is filled with removed toner (waste toner), the removed toner overflows to a side of the photoconductor drum, and the image forming apparatus is contaminated by the toner. As a result, a cleaning function of the cleaning unit can be maintained.

### BRIEF DESCRIPTION OF THE DRAWINGS

FIG. 1 is an explanatory diagram illustrating an entire constitution of an image forming apparatus according to a first embodiment of the present invention;

FIG. 2 is a perspective view illustrating a constitution of a toner cartridge unit having toner cartridges mounted to the image forming apparatus according to the first embodiment;

FIG. 3A is a side cross-sectional view of the toner cartridge illustrating a cross-sectional shape of a spiral blade in a screw shaft of the toner cartridge according to the first embodiment, FIG. 3B is a cross-sectional view taken along line A-A of the toner cartridge in FIG. 3A, FIG. 3C is a cross-sectional view taken along line B-B of the toner cartridge in FIG. 3A, and FIG. 3D is a cross-sectional view taken along line D-D of the toner cartridge in FIG. 3A;

FIG. 4 is a side cross-sectional view illustrating the toner cartridge according to the first embodiment;

FIG. 5 is a cross sectional view illustrating a part of the screw shaft of a toner conveying apparatus according to the first embodiment;

FIG. 6 is an exploded view illustrating a state that a rigid spiral section and a spiral spring section of the screw shaft are separated according to the first embodiment;

FIG. 7 is a partially cross sectional view describing a function of the spiral spring section of the screw shaft according to the first embodiment;

FIG. 8 is a partially cross sectional view illustrating a toner discharge section in the toner cartridge according to a second embodiment of the present invention;

FIG. 9 is schematic cross sectional view when the toner conveying apparatus in the image forming apparatus is viewed from an upstream side according to a third embodiment; and

FIG. 10 is a cross sectional view illustrating the toner conveying apparatus according to the third embodiment.

### DETAILED DESCRIPTION OF THE PREFERRED EMBODIMENTS

A toner conveying apparatus according to the present invention can be used as a toner conveying mechanism in an image forming apparatus of an electrophotographic system, such as monochrome or full-color copy machine, printer and facsimile apparatus, and a complex machine having their functions.

More specifically, the toner conveying apparatus of the present invention can be used as a toner conveying mechanism of a toner cartridge attached to an apparatus main body of the image forming apparatus detachably (interchangeably) or a toner conveying mechanism of a cleaning unit for eliminating residual toner on a surface of a photoconductor drum.

The toner conveying apparatus includes a toner conveying barrel and a screw shaft. The toner conveying barrel has a toner conveying path arranged inside, a toner inlet arranged on an upstream side of the toner conveying path in order to introduce toner from the outside into the toner conveying path, and a toner outlet arranged on a downstream side of the toner conveying path in order to discharge the toner out of the toner conveying path. The screw shaft is provided into the toner conveying barrel rotatably, and conveys the toner in the toner conveying path from the upstream side to the downstream side.

The screw shaft has a rotating shaft and a spiral blade that is mounted to the rotating shaft. The spiral blade has a rigid spiral section fixed to the rotating shaft, and a spiral spring section that is arranged on a position facing the toner outlet on a downstream side with respect to a downstream side end portion of the rigid spiral section.

Only an upstream side end portion of the spiral spring section is fixed to the downstream side end portion of the rigid spiral section or the rotating shaft portion near the downstream side end portion of the rigid spiral section. The spiral spring section can expand and contract elastically to a direction of the rotating shaft.

The toner conveying apparatus may be, concretely, constituted and combined in the following manner.

(1) The spiral blade is formed into a spiral shape where the rigid spiral section and the spiral spring section are continuous with each other.

In such a manner, the toner in the toner conveying path can be conveyed to the toner outlet and discharged smoothly without accumulation.

(2) The toner conveying barrel has a vibration imposing protrusion on an inner wall surface near the toner outlet. The vibration imposing protrusion contacts with the spiral spring section by means of rotation of the screw shaft so as to vibrate the spiral spring section.

In such a manner, when the screw shaft rotates and the spiral spring section contacts with the vibration imposing protrusion, the spiral spring section rotates along the vibration imposing protrusion and thus is compressed and deformed elastically to a direction of the rotating shaft. Thereafter, the downstream side end portion of the spiral spring section passes the vibration imposing protrusion or before that the spiral spring section is elastically deformed to go over the vibration imposing protrusion, and the spiral spring section is restored.

This series of operations allows the spiral spring section to vibrate to the direction of the rotating shaft, and the vibration continues during the rotation. For this reason, the toner adhered to the spiral spring section can be shaken off, and even if the toner is accumulated near the toner outlet, the accumulated toner can be shaken off by the vibration and a wind pressure caused by the vibration.

Further, when the toner agglutinates near the toner outlet, the spiral spring section repeatedly vibrates to the direction of the rotating shaft so that the agglutinated toner can be crumbed to be easily discharged via the toner outlet.

(3) The spiral blade is formed so that a gap is provided between the spiral spring section and the rotating shaft.

In such a manner, since the spiral spring section can move to a radial direction of the rotating shaft, particularly when the vibration imposing protrusion is provided, the spiral spring vibrates to the direction of the rotating shaft and the radial direction of the rotating shaft. For this reason, the toner adhered to the spiral spring can be effectively shaken off, and the agglutinated toner accumulated near the toner outlet can be effectively crumbed so as to be discharged outside via the toner outlet.

Embodiments of the present invention will be described in detail below with reference to the drawings. The present invention is not limited to the following embodiments.

### First Embodiment

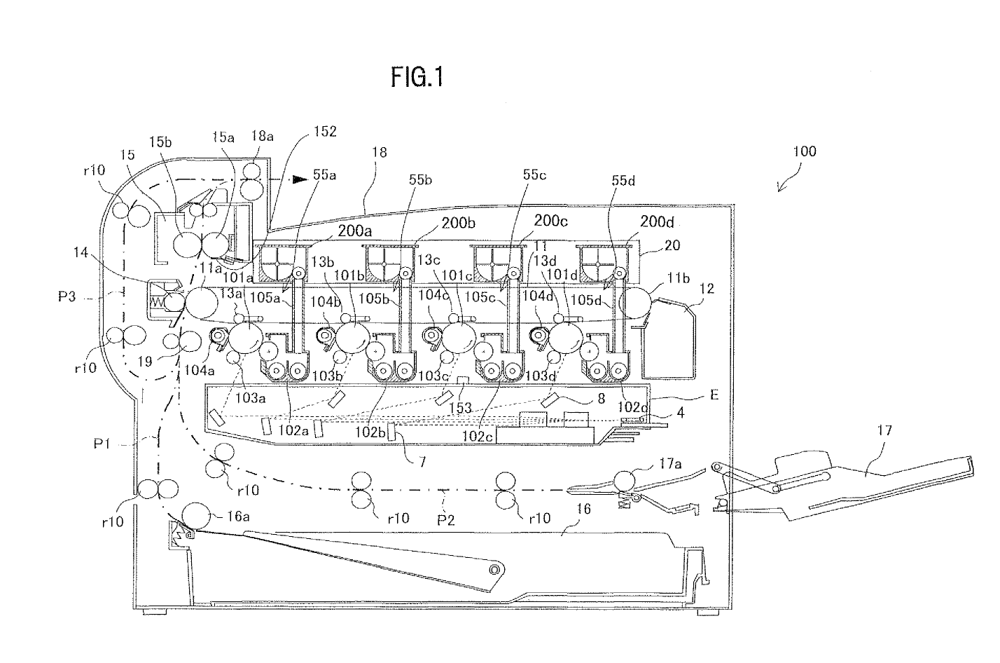

FIG. 1 is an explanatory diagram illustrating an entire constitution of the image forming apparatus according to a first embodiment of the present invention.

The image forming apparatus 100 according to the first embodiment has four image forming sections 55 (55a to 55d) as shown in FIG. 1. The imaging forming apparatus 100 is characterized by adopting toner cartridges 200 (200a to 200d), described later, provided to each image forming section 55.

The first embodiment illustrates a case of a printer for forming multicolor or monochrome images as visible images on predetermined sheets (recording sheet) based on image data included in input commands, such as image data transmitted externally via a communication network or the like. However, the image forming apparatus may be a copy machine, a facsimile apparatus or a complex machine having their functions that can form multicolor or monochrome images on recording media according to image data transmitted externally and/or image data read from documents using scanners.

### <Entire Constitution of Image Forming Apparatus>

The entire constitution of the image forming apparatus 100 is first described in detail below.

As shown in FIG. 1, the image forming apparatus 100 according to the first embodiment has an exposing unit E, the four image forming sections 55 (55a to 55d), an intermediate transfer belt 11, primary transfer rollers 13 (13a to 13d), a secondary transfer roller 14, a fixing section 15, sheet conveying paths P1, P2 and P3, a paper feeding cassette 16, a manual paper feeding tray 17, a discharge tray 18, and a toner cartridge unit 20.

The image forming sections 55 (55a to 55d) have photoconductor drums 101 (101a to 101d) corresponding to image supporting members on which latent image is formed by the exposing unit E, developing sections 102 (102a to 102d), charging rollers 103 (103a to 103d), cleaning units 104 (104a to 104d).

Color image data treated in the image forming apparatus 100 is image data that copes with hues of four colors including black (K), cyan (C), magenta (M) and yellow (Y). A visible image is formed by the image forming sections 55 (55a to 55d) based on the image data.

Therefore, the image forming sections 55 (55a to 55d) are provided with the developing sections 102 (102a to 102d), the photoconductor drum 101 (101a to 101d), the charging rollers 103 (103a to 103d), transfer rollers 13 (13a to 13d) and cleaning units 104 (104a to 104d), respectively, in order to form four kinds of latent images according to each color.

The image forming sections 55 (55a to 55d) are arranged on one line in a moving direction (vertical scanning direction) of the intermediate transfer belt 11.

Since the image forming sections 55a to 55d have the similar constitution, in this specification, in some cases, the image forming sections are denoted by unified symbol 55, and the photoconductor drums provided to the respective image forming sections are denoted by unified symbol 101, the developing sections are denoted by unified symbol 102, the charging rollers are denoted by unified symbol 103, the transfer rollers are denoted by unified symbol 13, and the cleaning units are denoted by unified symbol 104. As to the symbols a to d, a corresponds to black, b corresponds to cyan, c corresponds to magenta, and d corresponds to yellow. Four image stations are constituted by the respective units discriminated by these symbols.

The exposing unit E as an exposing device has a semiconductor laser, not shown, a polygon mirror 4, a first reflection mirror 7, and a second reflection mirror 8. The exposing unit E emits light beams such as laser beams modulated by image data with hues of black, cyan, magenta and yellow to the photoconductor drums 101a to 101d, respectively. Electrostatic latent images are formed on the photoconductor drums 101a to 101d by the image data with hues of black, cyan, magenta, and yellow.

In the first embodiment, the exposing unit E adopts a method using a laser scanning unit (LSU) having a laser emitting section and a reflection mirror, but may adopt a method using, for example, an EL or LED writing head where light emitting elements are arranged into an array pattern.

The photoconductor drum 101 is an image supporting member that is disposed above the exposing unit E and have approximately cylindrical shape. The photoconductor drum 101 is controlled so as to rotate to a predetermined direction by a drive unit and a control unit, not shown.

The photoconductor drum 101 has a base material made of a metal drum formed by, for example, aluminum, and a thin-film photoconductive layer that is laminated on an outer peripheral surface of the base material and is made of amorphous silicon (a-Si), selenium (Se) or organic optical semiconductor (organic photo-conductor: OPC). The constitution of the photoconductor drum 101 is not particularly limited to the above constitution.

The charging roller 103 is a contact-type charging unit that uniformly charges surface of the photoconductor drum 101 with a predetermined electric potential.

In the first embodiment, as shown in FIG. 1, the contact-type charging roller 103 is used as the charging unit, but instead of the charging roller 103, charger-type or brush-type charging unit may be used.

The developing section 102 supplies toner to the surface of the photoconductor drum 101 on which an electrostatic latent image is formed, and develops the electrostatic latent image into a toner image.

The respective developing sections 102a to 102d house black, cyan, magenta and yellow toners, respectively, and develop the electrostatic latent images formed on the photoconductor drums 101a to 101d corresponding to the respective hues into black, cyan, magenta, and yellow toner images.

The cleaning unit 104 removes toner that remains on the surface of the photoconductor drum 101 after development and image transfer using lubricant or the like and collects the toner.

The intermediate transfer belt 11 disposed above the photoconductor drums 101 is formed into an endless form by a film with a thickness of about 100 to 150 μm. The intermediate transfer belt 11 stretches between a drive roller 11a and a driven roller 11b arranged on a downstream side and an upstream side in a toner image conveying direction so as to form a loop-shaped transfer pathway.

As to the photoconductor drums 101 opposed to outer peripheral surface at a lower part of the intermediate transfer belt 11, the photoconductor drum 101d, the photoconductor drum 101c, the photoconductor drum 101b and the photoconductor drum 101a are disposed in this order starting from the upstream side of the toner image conveying direction.

The primary transfer rollers 13a to 13d are arranged on an inner peripheral side at a lower part of the intermediate transfer belt 11. The primary transfer rollers 13a to 13d touch the lower-part inner peripheral surface, push its lower-part outer peripheral surface against the photoconductor drums 101a to 101d. The positions of the intermediate transfer belt 11 that contact with the photoconductor drums 101a to 101d are primary transfer positions.

A primary transfer bias whose polarity is opposite to that of toner charging polarity is applied to the primary transfer rollers 13a to 13d by constant voltage control in order to transfer the toner images supported on the surfaces of the photoconductor drums 101a to 101d onto the intermediate transfer belt 11.

As a result, the toner images with the respective hues formed on the photoconductor drums 101a to 101d are sequentially transferred onto the outer peripheral surface of the intermediate transfer belt 11 in an overlapped manner. A full-color toner image is formed on the outer peripheral surface of the intermediate transfer belt 11.

When only image data with some hues of yellow, magenta, cyan and black are input, electrostatic latent images and toner images are formed on some of the four photoconductor drums 101a to 101d corresponding to the hues of the input image data.

For example, at the time of forming a monochrome image, an electrostatic latent image and a toner image are formed only on the photoconductor drum 101a corresponding to the hue of black, and only a black toner image is transferred to the outer peripheral surface of the intermediate transfer belt 11.

The primary transfer rollers 13a to 13d have a shaft made of metal with a diameter of 8 to 10 mm (for example, stainless steel), and a conductive and elastic material that covers a surface of this shaft (for example, EPDM or urethane foam). A high voltage is applied uniformly to the intermediate transfer belt 11 by the conductive and elastic material.

In the first embodiment, the primary transfer rollers 13a to 13d are used as transfer electrodes, but besides them, brushes can be used.

The toner images transferred onto the outer peripheral surface of the intermediate transfer belt 11 on the respective primary transfer positions are conveyed to second transfer positions opposed to the secondary transfer roller 14 by rotation of the intermediate transfer belt 11.

The secondary transfer roller 14 is brought into pressure-contact with the outer peripheral surface of the intermediate transfer belt 11 wrapped around the drive roller 11a by a predetermined nip pressure at the time of forming an image. In order to steadily obtain the nip pressure, any one of the secondary transfer roller 14 and the drive roller 11a is made of a hard material such as metal, and the other one is made of a soft material such as an elastic roller (an elastic rubber roller or a foamable resin roller).

When a sheet fed from the paper feeding cassette 16 or the manual paper feeding tray 17 passes the secondary transfer positions between the secondary transfer roller 14 and the intermediate transfer belt 11, a high voltage whose polarity (+) is opposite to a toner charging polarity (−) is applied to the secondary transfer roller 14.

The electrostatic latent images on the photoconductor drums 101a to 101d are developed by the toners corresponding to the hues so as to be toner images, and these toner images are laminated on the intermediate transfer belt 11. Thereafter, the laminated toner images are conveyed to the secondary transfer positions by the rotation of the intermediate transfer belt 11, and the toner images are transferred to the sheet conveyed to the secondary transfer positions.

The toners that are not transferred onto the sheet and remain on the intermediate transfer belt 11 cause color mixing of toners at next step. For this reason, an intermediate transfer belt cleaning unit 12 removes and collects them.

The intermediate transfer belt cleaning unit 12 is provided with a cleaning blade, for example, that contacts with the intermediate transfer belt 11. This cleaning blade is arranged so as to contact with the outer peripheral surface of the intermediate transfer belt 11 supported by the driven roller 11b.

The sheet onto which the toner images are transferred as visible images is guided to the fixing section 15 having a heating roller 15a and a pressurizing roller 15b. The sheet passes between the heating roller 15a and the pressurizing roller 15b, and is subject to heating and pressurizing processes. As a result, the toner images to be the visible images are firmly fixed to the surface of the sheet.

The sheet to which the toner images are fixed is discharged onto the discharge tray 18 by a discharge roller 18a.

The image forming apparatus 100 is provided with a sheet conveying path P1 in an approximately vertical direction for conveying sheets housed in the paper feeding cassette 16 to the discharge tray 18 via between the secondary transfer roller 14 and the intermediate transfer belt 11 and via the fixing section 15.

On the sheet conveying path P1, a pickup roller 16a, a conveying roller r10, a registration roller 19 and a discharge roller 18a are disposed. The pickup roller 16a feeds the sheets in the paper feeding cassette 16 into the sheet conveying path P1 one by one. The conveying roller r10 conveys the fed sheets upward. The registration roller 19 guides the conveyed sheets between the secondary transfer roller 14 and the intermediate transfer belt 11 at predetermined timing. The discharge roller 18a discharges the sheets onto discharge tray 18.

A sheet conveying path P2 is provided between the manual paper feeding tray 17 and the registration roller 19 inside the image forming apparatus 100. A pickup roller 17a and the conveying roller r10 are arranged on the sheet conveying path P2.

A sheet conveying path P3 is formed between the discharge roller 18a and an upstream side of the registration roller 19 on the sheet conveying path P1.

The discharge roller 18a is provided rotatably to both regular and reverse directions. The discharge roller 18a is driven to the regular rotating direction to discharge the sheet onto the discharge tray 18 at the time of one-side image formation where an image is formed on one side of the sheet and second side image formation of double-side image formation where an image is formed on both sides of the sheet.

On the other hand, at first side image formation of the double-side image formation, the discharge roller 18a is driven to the regular rotating direction until a rear end of the sheet passes the fixing section 15, and is driven to the reverse rotating direction with the rear end of the sheet being nipped so as to guide the sheet into the sheet conveying path P3. As a result, the sheet whose one side is formed with an image at the time of the double-side image formation is guided to the sheet conveying path P1 with its front and rear sides and forward and rear ends being reversed.

The registration roller 19 guides the sheet, that is fed from the paper feeding cassette 16 or the manual paper feeding tray 17 or fed via the sheet conveying path P3, between the secondary transfer roller 14 and the intermediate transfer belt 11 at timing synchronous with the rotation of the intermediate transfer belt 11.

For this reason, when the photoconductor drum 101 or the intermediate transfer belt 11 starts to operate, the rotation of the registration roller 19 is stopped, and thus transportation of the sheet that is fed or conveyed prior to the rotation of the intermediate transfer belt 11 in the sheet conveying path P1 is stopped with its forward end contacting with the registration roller 19. Thereafter, the registration roller 19 starts to rotate on a position where the secondary transfer roller 14 pressure-contacts with the intermediate transfer belt 11 at timing at which the forward end of the sheet faces front ends of toner images formed on the intermediate transfer belt 11.

At the time of the full-color image formation where images are formed on all the image forming sections 55a to 55d, the primary transfer rollers 13a to 13d allow the intermediate transfer belt 11 to pressure-contact with all the photoconductor drums 101a to 101d. On the other hand, at the time of the monochrome image formation where an image is formed only on the image forming section 55a, only the primary transfer roller 13a allows the intermediate transfer belt 11 to pressure-contact with the photoconductor drum 101a.

### <Constitution of Toner Cartridge>

A constitution of the toner cartridge 200 according to the first embodiment will be described below with reference to the drawings.

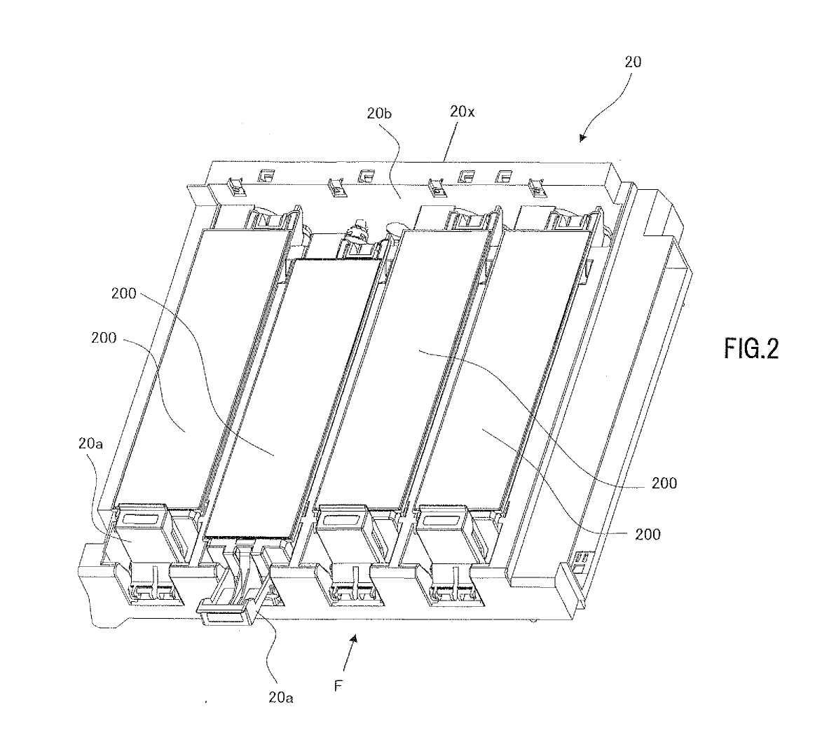

FIG. 2 is a perspective view illustrating a constitution of the toner cartridge unit having the toner cartridges mounted to the image forming apparatus according to the first embodiment.

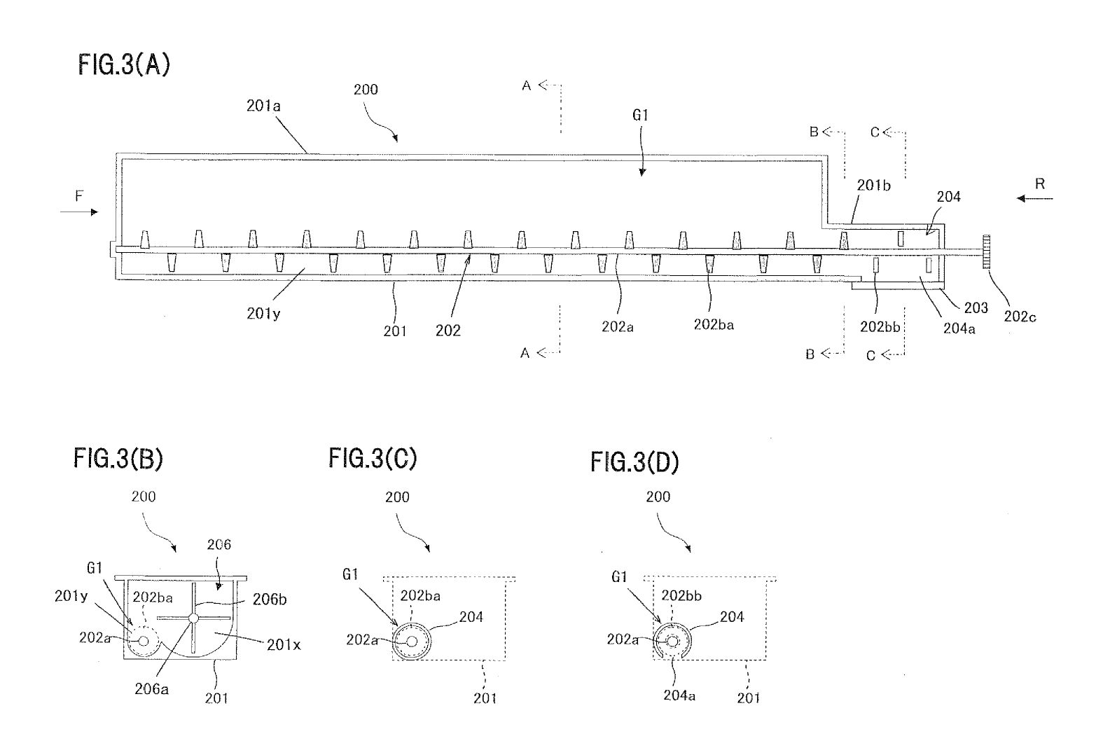

FIG. 3A is a side cross sectional view of the toner cartridge illustrating a cross-sectional shape of the spiral blade in the screw shaft of the toner cartridge in the first embodiment. FIG. 3B is a cross sectional view taken along line A-A of the toner cartridge in FIG. 3A, FIG. 3C is a cross sectional view taken along line B-B of the toner cartridge in FIG. 3A, and FIG. 3D is a cross sectional view taken along line D-D of the toner cartridge in FIG. 3A.

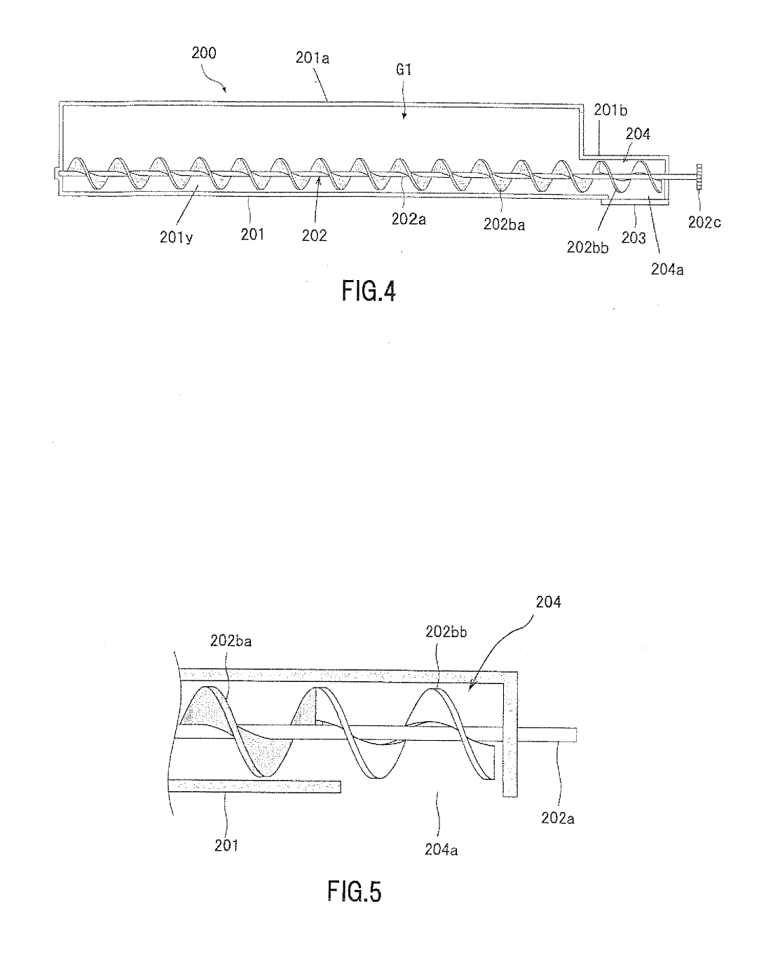

FIG. 4 is a side cross-sectional view illustrating the toner cartridge according to the first embodiment.

As shown in FIGS. 2 to FIG. 4, the toner cartridge 200 has a cartridge main body 201, a toner conveying apparatus G1 provided in the cartridge main body 201 according to the present invention and a paddle member 206.

Concretely, the toner cartridge 200 has the cartridge main body 201, a shutter 203, the screw shaft 202, and the paddle member 206. The cartridge main body 201 for housing toners is formed into a sealed container shape that is long in one direction, and has a toner outlet 204a on one end in its longitudinal direction. The shutter 203 is provided on an outer surface of the cartridge main body 201 and opens/closes the toner outlet 204a. The screw shaft 202 is provided in the cartridge main body 201 rotatably about the rotating shaft in the longitudinal direction and on a position overlapped with the toner outlet 204a, and conveys a toner (not shown) in the cartridge main body 201 to the toner outlet 204a. The paddle member 206 has a rotating shaft 206a parallel with a rotating shaft 202a of the screw shaft 202 in the cartridge main body 201, and feeds the toner in the cartridge main body 201 to the screw shaft 202.

In the toner cartridge 200, the cartridge main body 201 has an approximately rectangular parallelepiped portion 201a, and a protruded portion 201b connected to one end of the approximately rectangular parallelepiped portion 201a in the longitudinal direction. One end of the rotating shaft 202a of the screw shaft 202 in the cartridge main body 201 penetrates a side wall of the protruded portion 201b to protrude outside, and is provided with a drive gear 202c.

The four toner cartridges 200 are attached to a toner cartridge holder 20x in an arranged manner as shown in FIG. 2, and they compose the toner cartridge unit 20.

The toner cartridge holder 20x is of an upper-opened container type, has four concave portions inside that are separated by sectional walls. The four concave portions house the toner cartridges 200.

Window portions and notched portions are formed on both wall portions of the concave portions in the longitudinal direction of the toner cartridge holder 20x. Drive gears 202c of the toner cartridges 200 are inserted into the window sections, respectively. Lock levers 20a are mounted to the notched portions swingably.

The toner cartridges 200 are fitted into the concave portions of the toner cartridge holder 20x, and the lock levers 20a of the toner cartridge holder 20x are lifted, so that the cartridge main body 201 is moved to a right direction (a direction of arrow F). The toner cartridges 200 are held with them being pushed against a stopper plate 20b of the toner cartridge holder 20.

Notched window sections (not shown) are formed on bottom walls of the concave sections of the toner cartridge holder 20x across positions opposed to the toner outlets 204a of the attached toner cartridges 200 and edges of their vicinities.

When the toner cartridge unit 20 is attached to the image forming apparatus, the toner cartridges 200 move to an approximately vertical direction (approximately horizontal direction with respect to toner replenish pipes 105). As a result, end surfaces of the shutters 203 with upper ends of the toner replenish pipes 105 passing the notched window sections. When the shutters 203 move to the approximately horizontal direction and the toner outlets 204a are arranged on positions opposed to the toner replenish pipes 105, the toner outlets 204a are opened (see FIG. 1).

Gears are provided to the image forming apparatus. The gears are engaged with drive gears on sides of the paddle members 206 of the toner cartridges 200 and drive gears on sides of the screw shafts 202, and transmit a rotation force from a drive motor.

The cartridge main body 201 has a toner housing section 201x and a toner conveying path 201y. The toner housing section 201x is a large-volume space in which the paddle member 206 is arranged, and houses most of toner (not shown). The toner conveying path 201y is a small-volume space where the screw shaft 202 is arranged, and is connected to the toner housing section 201x adjacently. The toner outlet 204a is arranged on one end of the toner conveying path 201y in the longitudinal direction.

The one end of the toner conveying path 201y in the longitudinal direction is an internal space of the protruded portion 201b in the cartridge main body 201, and is a toner discharge section 204 having the toner outlet 204a.

That is to say, the cartridge main body 201 is formed so that the toner conveying path 201y protrudes to one end in the longitudinal direction further than the toner housing section 201x. The toner outlet 204a is arranged in a protruded space of the toner conveying path 201y that is protruded to one end in the longitudinal direction further than the toner housing section 201x.

Bottom surfaces of the toner housing section 201x and the toner conveying path 201y are formed into an arc shape.

The toner outlet 204a is a square opening provided to a bottom portion of the toner discharge section 204, and is for discharging toner conveyed by the screw shaft 202 out of the toner cartridge 200.

The shutter 203 is the plate-like shutter having an approximately square shape provided slidably to a position where the toner outlet 204a is closed. When the toner cartridge 200 is attached to the image forming apparatus, the shutter 203 opens the toner outlet 204a.

Before the toner cartridge 200 is attached to the image forming apparatus, the shutter 203 is elastically biased to a direction where the toner outlet 204a is closed by a spring member, not shown, for example.

The paddle member 206 has a rotating shaft 206a, and four rectangular impeller blades 206b mounted to the rotating shaft 206a.

One end of the rotating shaft 206a rotatably penetrates a side wall at one end of the cartridge main body 201 in the toner housing section 201x in the longitudinal direction. A drive gear, not shown, is mounted to its one end.

Further, the other end of the rotating shaft 206a is rotatably fitted into the concave portion provided to a side wall on the other end of the cartridge main body 201 in the longitudinal direction in the toner housing section 201x so as to be supported.

The impeller blade 206b is made of a flexible sheet member having suitable flexibility and rigidity such as a resin sheet (for example, a PET sheet) or a rubber sheet. The impeller blade 206b has a length slightly shorter than a length of the toner housing section 201x and a width for allowing the impeller blade 206b to slidably contact with the bottom surface of the toner housing section 201 or to come close to the bottom surface.

When the rotating shaft 206a rotates from down to above to the toner conveying path 201y, the paddle member 206 crumbs the toner in the toner housing section 201x, and feeds the crumbed toner into the toner conveying path 201y.

### [Constitution of Toner Conveying Apparatus]

The toner conveying apparatus G1 according to the present invention has a basic constitution provided with the toner conveying barrel and the screw shaft disposed rotatably into the toner conveying barrel.

In the case of the first embodiment, the toner conveying apparatus G1 is integral with the cartridge main body 201, and is incorporated as a part of the constitution of the toner cartridge 200.

Concretely, in the toner conveying apparatus G1, the toner conveying barrel composes a wall section around the screw shaft 202 in the cartridge main body 201. The toner conveying barrel has the toner conveying path 201y, the toner inlet, and the toner outlet 204a. The toner inlet is arranged on an upstream side of the toner conveying path 201y in order to introduce toner from the outside into the toner conveying path 201y. The toner outlet 204a is arranged on a downstream side of the toner conveying path 201y in order to discharge the toner out of the toner conveying path 201y.

Therefore, the toner cartridge 200 has the cartridge main body 201, the shutter 203 and the paddle member 206. The cartridge main body 201 includes the toner conveying apparatus G1, and the toner housing section 201x arranged adjacently to the toner conveying apparatus G1. The shutter 203 is provided on an outer surface of the cartridge main body 201, and opens/closes the toner outlet 204a. The paddle member 206 is provided rotatably into the cartridge main body 201, and feeds the toner in the toner housing section 201x from the toner inlet into the toner conveying path 201y.

The toner inlet corresponds to a connecting portion on a boundary between the toner housing section 201x and the toner conveying path 201y.

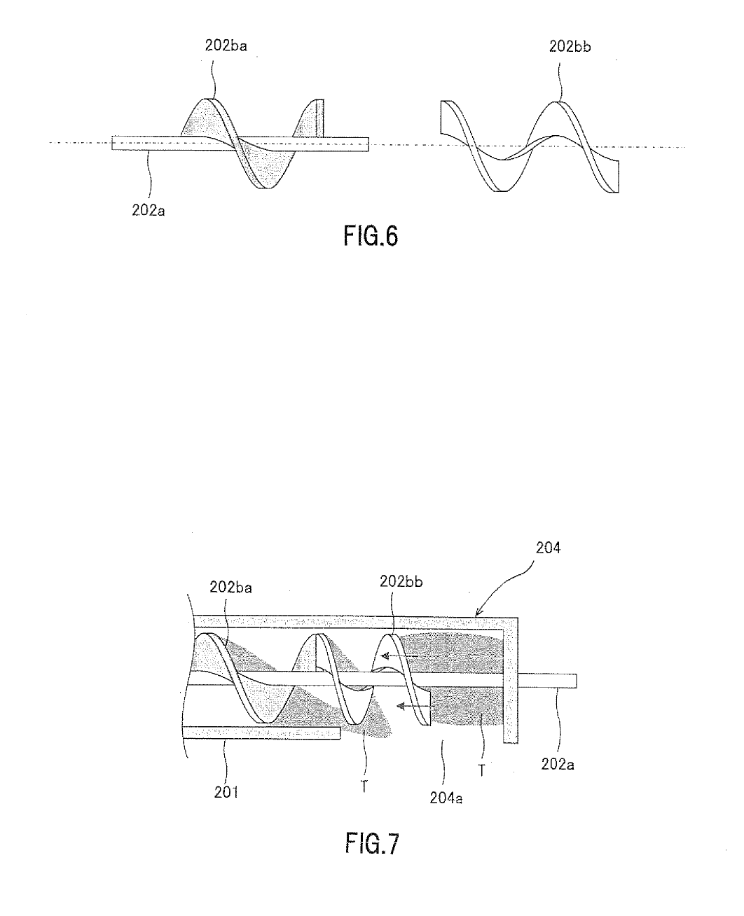

FIG. 5 is a cross sectional view illustrating a part of the screw shaft of the toner conveying apparatus in the first embodiment. FIG. 6 is an exploded view illustrating a state that the rigid spiral section and the spiral spring section of the screw shaft in the first embodiment are separated. FIG. 7 is a partially cross-sectional view describing a function of the spiral spring section of the screw shaft in the first embodiment.

As shown in FIGS. 5 to 7, the screw shaft 202 has the rotating shaft 202a, and the spiral blade mounted to the rotating shaft 202a.

The spiral blade is composed of a rigid spiral section 202ba entirely fixed to the rotating shaft 202a, and a spiral spring section 202bb arranged on a position facing the toner outlet 204a on the downstream side with respect to the downstream side end portion of the rigid spiral section 202ba.

The spiral spring section 202bb is a spiral band-shaped body having suitable rigidity and flexibility, such as a spiral band-shaped body made of synthetic resin such as PET resin. The spiral spring section 202bb is constituted so as to have a spiral direction that is the same as that of the rigid spiral section 202ba and be capable of elastically expanding and contracting to a rotation axial direction.

A spring constant k of the spiral spring section 202bb (k=P/δ, k: spring constant (N/mm), P: load (N), δ: displacement in the rotation axial direction (mm)) is preferably 0.01 to 0.1, and more preferably 0.02 to 0.06.

When the spring constant k is less than 0.01, a toner conveying amount becomes easily unstable, and on the contrary, when exceeds 0.1, it is difficult to obtain a toner compression preventing effect.

Only an upstream side end portion of the spiral spring section 202bb is fixed to a downstream side end portion of the rigid spiral section 202ba. As a result, the spiral blade is formed into a spiral shape so that the rigid spiral section 202ba and the spiral spring section 202bb are continuous. The upstream side end portion of the spiral spring section 202bb may be fixed to the rotating shaft 202a, and in this case, it is preferable for preventing accumulation of toner on a gap that the rigid spiral section 202ba and the spiral spring section 202bb are continuous without a gap.

Further, a width of the spiral spring section 202bb is set so as to be slightly narrower than a width of the rigid spiral section 202ba. As a result, a gap (for example, the gap of about 0.5 to 2 mm) is formed between the spiral spring section 202bb and the rotating shaft 202a so that the spiral spring section 202bb can vibrate to a radial direction with respect to the rotating shaft 202a.

This gap may not be provided, and thus the spiral spring section 202bb may entirely contact with the rotating shaft 202a.

### [Working Effect of Toner Cartridge]

When the toner cartridge 200 is attached to the image forming apparatus, the shutter 203 opens, and the toner outlet 204a and the toner replenish pipe 105 are connected.

When the image forming apparatus is driven, the paddle member 206 rotates to crape out toners in the toner housing section 201x and feed them to the toner conveying path 201y. The screw shaft 202 rotates to feed the toner in the toner conveying path 201y to the toner discharge section 204. The toner pass the toner outlet 204a and the toner replenish pipe 105 so as to be supplied to the developing device 102 (see FIG. 1).

At this time, when fluidity of the toner is deteriorated, the toners conveyed by the screw shaft 202 is occasionally accumulated near the toner outlet 204a instantaneously. However, as shown in FIG. 7, the spiral spring section 202bb constricts to be deformed to the rotation axial direction, so that application of an excessive compressing force to the toner T can be repressed.

As a result, the consolidation state of the toner T is repressed, a lock phenomenon caused by the consolidation state of the toner T is prevented.

Even if the toner T whose fluidity is temporarily low is accumulated near the toner outlet 204a, the spiral spring section 202bb continuously rotates, and thus the toner T is discharged from the toner outlet 204a. As a result, the compressed spiral spring section 202bb is restored.

### Second Embodiment

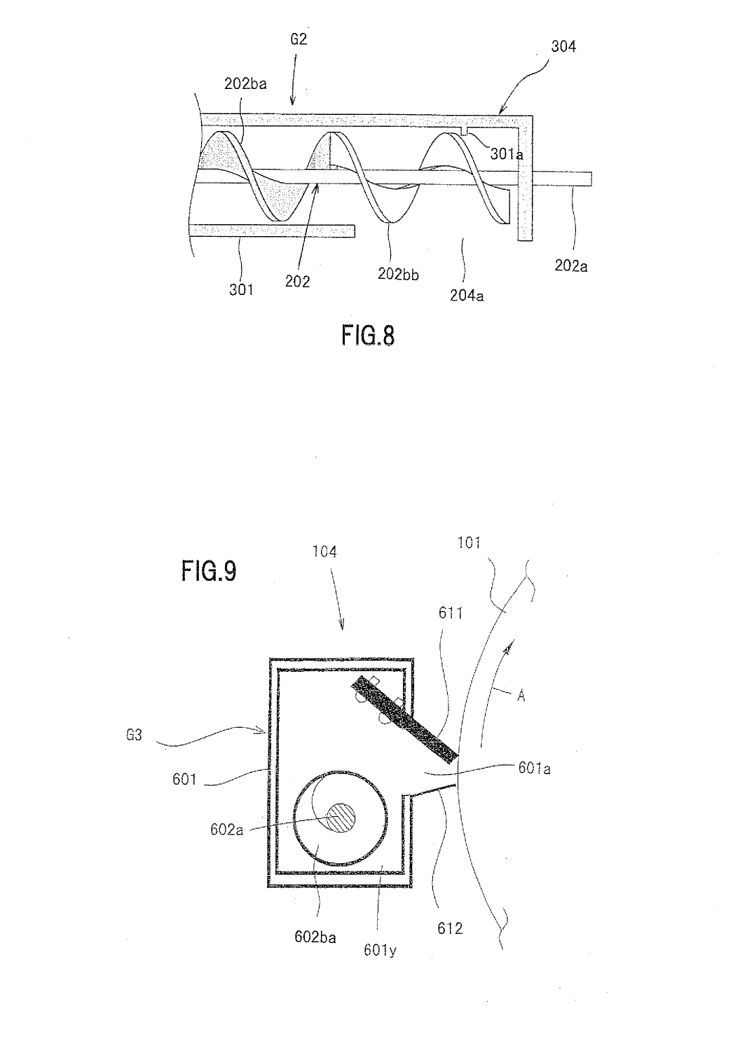

FIG. 8 is a partially cross sectional view illustrating the toner discharge section in the toner cartridge according to a second embodiment of the present invention. In FIG. 8, the same elements as those in FIG. 5 are denoted by the same reference symbols.

The toner cartridge according to the second embodiment has the similar constitution as that of the toner cartridge in the first embodiment except of a difference in a partial shape of the cartridge main body 301 housing toner. A point of the second embodiment different from the first embodiment is mainly described below.

The cartridge main body 301 has the vibration imposing protrusion 301a on an inner wall surface of an approximately cylindrical shape above the toner outlet 304a in a toner discharge section 304 of the toner conveying apparatus G2. When the screw shaft 202 rotates, the vibration imposing protrusion 301a contacts with the spiral spring section 202bb so as to vibrate the spiral spring section 202bb.

If the spiral spring section 202bb touches the vibration imposing protrusion 301a, the vibration imposing protrusion 301a may be provided to the inner wall surface of the approximately cylindrical shape on the side of the toner outlet 304a in the toner discharge section 304.

With the toner cartridge, when the screw shaft 202 rotates and the spiral spring section 202bb contacts with the vibration imposing protrusion 301a, the spiral spring section 202bb rotates with it contacting with the vibration imposing protrusion 301a. For this reason, the spiral spring section 202bb is elastically compressed to the rotation axial direction. Thereafter, the downstream side end portion of the spiral spring section 202bb passes the vibration imposing protrusion 301a or before that the spiral spring section 202bb is elastically deformed to go over the vibration imposing protrusion 301a, and the spiral spring section 202bb is restored.

This series of the operations allows the spiral spring section 202bb to vibrate in the rotation axial direction and the radial direction and the vibration continues during the rotation. For this reason, the toner adhered to the spiral spring section 202bb can be shaken off, and even if the toner is accumulated near the toner outlet 204a, the accumulated toner can be shaken off by the vibration and a wind pressure caused by the vibration.

When the toner agglutinates near the toner outlet 204a, the spiral spring section 202bb repeatedly vibrates in the rotation axial direction and the radial direction. As a result, the agglutinated toner is crumbed and can be easily discharged from the toner outlet 204a.

### Third Embodiment

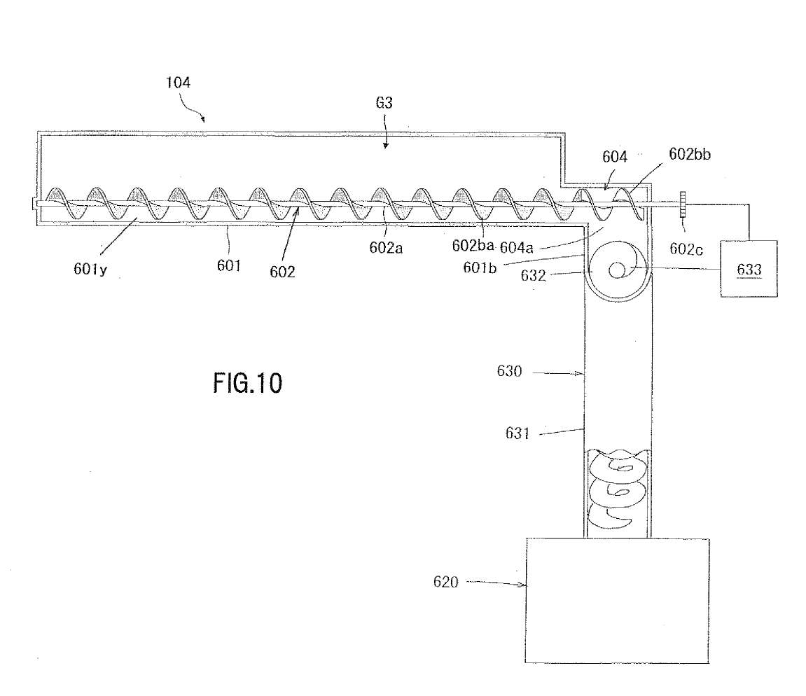

FIG. 9 is a schematically cross sectional view when the toner conveying apparatus in the image forming apparatus according to a third embodiment is viewed from the upstream side. FIG. 10 is a cross sectional view illustrating the toner conveying apparatus according to the third embodiment.

The first and second embodiments illustrate the case where the toner conveying apparatus is provided to the toner cartridge of the image forming apparatus.

On the other hand, the third embodiment illustrates a case where a toner conveying apparatus G3 is provided to the cleaning unit 104 (see FIG. 1) of the image forming apparatus.

As shown in FIG. 9, the image forming apparatus in the third embodiment further includes a waste toner collecting section 620, and a relay conveying device 630 that connects the cleaning unit 104 and the waste toner collecting section 620.

The cleaning unit 104 removes residual toner on the surface of the photoconductor drum 101 remaining after transfer as described above.

The toner conveying apparatus G3 provided to the cleaning unit 104 includes a toner conveying barrel 601 of an approximately rectangular parallelepiped shape and a screw shaft 602. The toner conveying barrel 601 has a toner conveying path 601y, a toner discharge section 604 having a toner outlet 604a arranged on a downstream side of the toner conveying path 601y, and a toner inlet 601a opened on a side of the photoconductor drum 101. The screw shaft 602 is provided into the toner conveying barrel 601 rotatably and has the same constitution as that in the first embodiment.

In FIG. 10, the reference symbol 602a denotes a rotating shaft, 602ba denotes a rigid spiral section, 602bb denotes a spiral spring section, and 602c denotes a drive gear.

The cleaning unit 104 includes the toner conveying apparatus

G3, an upper blade member (cleaning blade) 611 and a lower blade member (waste toner drop preventing mylar) 612 that are mounted to upper and lower opening edges of the toner inlet 601a in the toner conveying barrel 601 of the toner conveying apparatus G3.

The upper blade member 611 is made of a rubber type member with predetermined rigidity. The upper blade member 611 is mounted to the toner conveying barrel 601 by a screw with it being tilted down towards a forward end side so as to touch the surfaces of the photoconductor drum 101 and scrape off residual toner.

The lower blade member 612 is made of a plastic material. The lower blade member 612 is mounted to the toner conveying barrel 601 with it being tilted upward towards the front end side so as to receive residual toner dropped from the surface of the photoconductor drum 101 by the upper blade member 611 and guides the residual toner into the toner conveying path 601y.

In FIG. 9, an arrow A indicates a rotational direction of the photoconductor drum 101.

The relay conveying device 630 includes a relay conveying path 631, a coil spring 632 and a drive section 633. The relay conveying path 631 is made of a flexible tube that connects the toner outlet 604a of the toner conveying apparatus G3 and the waste toner collecting section 620. The coil spring 632 is provided into the relay conveying path 631 rotatably. The drive section 633 rotates to drive the coil spring 632.

More specifically, an L-shaped connecting barrel section 601b, that is connected to the toner outlet 604a, is provided at an end on the downstream side of the toner conveying barrel 601. A lower end of the connecting barrel section 601b is opened to a direction perpendicular to the toner outlet 604a, and is connected to the relay conveying path 631. An end of the coil spring 632 on the upstream side of the conveyance is arranged in the connecting barrel section 601b.

The drive section 633 of the relay conveying apparatus 630 includes, for example, an interlocking shaft, a rotational plate, not shown, and a transmission gear, not shown. The interlocking shaft penetrates a side wall of the connecting barrel section 601b and is pivotally attached rotatably. The rotational plate is fastened to an end of the interlocking shaft on an inner side of the connecting barrel section 601b. The transmission gear transmits a rotational force of the rotating 602a of the screw shaft 602 to the interlocking shaft. An end portion of the coil spring 632 on the conveyance upstream side is connected to the rotational plate.

The waste toner collecting section 620 includes an outside box and a waste toner collecting box. The outside box has an upper connecting port that is connected to the conveyance downstream side of the relay conveying path 631. The waste toner collecting box having an upper opening is attached to the outside box detachably.

The cleaning unit 104 having such a constitution flicks residual toner, sheet dust and the like adhered to the surface of the photoconductor drum 101 using the following phenomenon. The phenomenon is such that the front end of the upper blade member 611 that contacts with the outer peripheral surface of the photoconductor drum 101 with a predetermined pressure is flipped from the surface of the rotating photoconductor drum 101 (so-called “a stick-slip phenomenon”). The flicked residual toner and the like is introduced into the toner conveying barrel 601 by the lower blade member 612.

In the cleaning unit 104 having such a constitution, the rotation of the screw shaft 602 conveys the waste toner, sheet dust and the like introduced into the toner conveying barrel 601 to the toner outlet 604a similarly to the first embodiment so as to be fed to the relay conveying apparatus 630.

Also in this case, similarly to the first embodiment, the lock phenomenon that waste toner is brought into the consolidation state in the toner discharge section 604 in the cleaning unit 104 is prevented.

On the other hand, at the time of the rotation of the screw shaft 602, the drive section 633 of the relay conveying apparatus 630 is interlocked and the coil spring 632 also rotates. The waste toner in the relay conveying path 631 is conveyed through the relay conveying path 631 by the rotating coil spring 632 so as to be dropped into the waste toner collecting section 620.

When a certain amount of the waste toner (including residual toner and sheet dust) collected into the waste toner collecting section 620 is accumulated, or after the cleaning unit 104 is driven for a predetermined time, or at the time of periodical maintenance, the waste toner housing box is removed from the outside box so that the waste toner is wasted.

### Another Embodiment

The vibration imposing protrusion 301a (see FIG. 8) described in the second embodiment may be provided to an inner side wall of the toner discharge section 604 in the toner conveying barrel 601 in the toner conveying apparatus G3 according to the third embodiment.

What is claimed is:

1. A toner conveying apparatus comprising:
a toner conveying barrel having a toner conveying path arranged inside, a toner inlet arranged on an upstream side of the toner conveying path in order to introduce toner from an outside into the toner conveying path and a toner outlet arranged on a downstream side of the toner conveying path in order to discharge the toner out of the toner conveying path; and
a screw shaft provided in the toner conveying barrel rotatably and conveying the toner in the toner conveying path from the upstream side to the downstream side, wherein
the screw shaft has a rotating shaft and a spiral blade mounted to the rotating shaft,
the spiral blade has a rigid spiral section fixed to the rotating shaft, and a spiral spring section arranged on a position facing the toner outlet on a downstream side with respect to a downstream side end portion of the rigid spiral section,
only an upstream side end portion of the spiral spring section is fixed to the downstream side end portion of the rigid spiral section or the rotating shaft portion near the downstream side end portion of the rigid spiral section, and the spiral spring section can elastically expands and contracts to a direction of the rotating shaft.

2. The toner conveying apparatus according to claim 1, wherein the spiral blade is formed into a spiral shape where the rigid spiral section and the spiral spring section are continuous with each other.

3. The toner conveying apparatus according to claim 1, wherein the toner conveying barrel has a vibration imposing protrusion on an inner wall surface near the toner outlet so that the vibration imposing protrusion contacts with the spiral spring section by means of rotation of the screw shaft so as to vibrate the spiral spring section.

4. The toner conveying apparatus according to claim 1, wherein the spiral blade is formed so that a gap is provided between the spiral spring section and the rotating shaft.

5. A toner cartridge comprising:
a cartridge main body having the toner conveying apparatus according to claim 1 and a toner housing section arranged adjacently to the toner conveying apparatus inside;
a shutter provided on an outer surface side of the cartridge main body, for opening/closing the toner outlet in the toner conveying barrel; and
a paddle member, provided into the cartridge main body rotatably, for feeding the toner in the toner housing section from the toner inlet in the toner conveying barrel into the toner conveying path.

6. A cleaning unit comprising the toner conveying apparatus according to claim 1 and a blade member mounted to an opening edge of the toner inlet in the toner conveying barrel of the toner conveying apparatus.

7. An image forming apparatus comprising:
a photoconductor drum whose surface is formed with an electrostatic latent image;
a developing section for supplying toner to the electrostatic latent image on the surface of the photoconductor drum and forming a toner image;
the toner cartridge according to claim 5 for replenishing the developing section with toner;
a transfer section for transferring the toner image on the surface of the photoconductor drum to a recording medium; and
a fixing section for fixing the toner image to the recording medium.

8. An image forming apparatus comprising:
a photoconductor drum whose surface is formed with an electrostatic latent image;
a developing section for supplying toner to the electrostatic latent image on the surface of the photoconductor drum and forming a toner image;
a transfer section for transferring the toner image on the surface of the photoconductor drum to a recording medium;
a fixing section for fixing the toner image to the recording medium;
a waste toner collecting section; and
the cleaning unit according to claim 6 in which the blade member is provided to touch the surface of the photoconductor drum, wherein
a residual toner on the surface of the photoconductor drum remaining after the transfer is removed by the cleaning unit, and is conveyed to the waste toner collecting section.
